(19) United States
(12) Patent Application Publication
(10) Pub. No.: US 2016/0238019 A1
(43) Pub. Date: Aug. 18, 2016

(54) GAS PIPELINE CENTRIFUGAL COMPRESSOR AND GAS PIPELINE

(71) Applicant: HITACHI, LTD., Tokyo (JP)

(72) Inventors: Hiromi KOBAYASHI, Tokyo (JP); Kiyotaka HIRADATE, Tokyo (JP); Kazuyuki SUGIMURA, Tokyo (JP); Toshio ITO, Tokyo (JP); Hideo NISHIDA, Tsuchiura (JP)

(73) Assignee: HITACHI, LTD., Tokyo (JP)

(21) Appl. No.: 15/021,572

(22) PCT Filed: Sep. 11, 2014
(86) PCT No.: PCT/JP2014/074060

§ 371 Date: Mar. 11, 2016

(30) Foreign Application Priority Data
Oct. 28, 2013 (JP) 2013-223303

(51) Int. Cl. F04D 29/28; F17D 1/07; F04D 29/44; F04D 29/46; F04D 17/12; F04D 27/00

(52) U.S. Cl. CPC F04D 29/286; F04D 17/12; F04D 27/007; F04D 29/441; F04D 29/464; F17D 1/07

(57) ABSTRACT

A centrifugal compressor 200 used in a gas pipeline 1 has a centrifugal impeller provided with a hub and a plurality of blades. The blade angle distribution of the blade is configured such that a hub side blade angle is maximum on the side closer to a hub side leading edge than a central point of a hub side camber line, and from this part to the hub side leading edge, a hub side blade angle distribution curve is convex in a blade angle increasing direction. Further, the blade angle distribution is configured such that a counter-hub side blade angle is minimum at a counter-hub side leading edge of the counter-hub side camber line, or on the side closer to the counter-hub side leading edge than a central point of a counter-hub side camber line, and in an arbitrary section of the counter-hub side blade angle distribution curve including a part where the blade angle is minimum, the counter-hub side blade angle distribution curve is convex in a small blade angle direction, and in a section from the downstream side of the section where the counter-hub side blade angle distribution curve is convex to the counter-hub side trailing edge, the counter-hub side blade angle distribution curve is convex in a large blade angle direction. With this arrangement, it is possible to obtain a gas pipeline centrifugal compressor in which the low flow-rate side operating range is expanded and a high flow-rate side operating range is maintained.

### BACKGROUND OF THE INVENTION

1. Field of the Invention

The present invention relates to a gas pipeline centrifugal compressor having a centrifugal impeller and a gas pipeline, and more particularly, to a blade shape of the centrifugal impeller in a pipeline centrifugal compressor.

2. Description of the Related Art

Among industrial compressors, in a centrifugal compressor used as a booster for a gas pipeline, high efficiency and wide operating range are required. When the reserve of petroleum oil and natural gas pumped up from a well site of an oil field is reduced, the production is reduced due to depletion. Accordingly, flow rate control corresponding to the depletion is necessary.

As a flow rate control method for the centrifugal compressor, control of the number of units, valve control, rotation velocity control, inlet guide vane control and the like are known. When the flow rate is drastically reduced, the control of the number of units is effective. However, when the flow rate is changed (reduced) little by little, the control of the number of units is not available. When the flow rate is changed little by little, the rotation velocity control or the inlet guide vane control may be adopted, however, it is difficult to adopt these control methods from the points of cost, long-term reliability and maintainability.

Accordingly, as a gas pipeline centrifugal compressor, required is a compressor having a wide operating range corresponding to flow rate change to a certain degree without execution of controls as described above.

The operating range of the centrifugal compressor is generally determined based on surge on the low flow rate side while on choking on the high flow rate side, which much depends on design of the centrifugal impeller as a main element of the compressor. Accordingly, to realize a compressor having a wide operating range, the design of the impeller is important.

Note that as a designing method related to blades of the impeller of the centrifugal compressor, the methods described in the following patent literature 1 and 2 and non-patent literature 1 are known.

### CITATION LIST

### Patent Literature

[Patent Literature 1] Japanese Patent Laid-Open No. 2010-151126

[Patent Literature 2] Japanese Patent No. 3693121

### Non-Patent Literature

[Non-Patent Literature 1] M. Zangeneh, A. Goto, and H. Harada: “On the Design Criteria for Suppression of Secondary Flows in Centrifugal and Mixed Flow Impellers”, ASME Journal of Turbomachinery, vol. 120, pp. 723-735, October 1998

### SUMMARY OF THE INVENTION

### Technical Problem

In the centrifugal compressor described in the above-described patent literature 1, to expand the operating range and improve the efficiency, and to increase the circumferential velocity of the impeller, the blade angle of the impeller blade is set as follows.

That is, the blade angle in a shroud-side blade angle curve of the blade takes a minimum value in the vicinity of a leading edge and is increased toward a trailing edge, and takes a maximum value between an intermediate point in the shroud-side blade angle curve and the trailing edge. On the other hand, the blade angle in a hub-side blade angle curve of the blade is increased from the leading edge toward the trailing edge, and takes a maximum value between an intermediate point in the hub-side blade angle curve and the leading edge.

In the centrifugal compressor described in the patent literature 1, on the shroud side of the impeller, the blade angle is minimum in the vicinity of the blade leading edge. In a status of the impeller viewed from the suction side (axial direction), the blade is closer to the circumferential direction in the vicinity of the shroud-side leading edge. Accordingly, a throat area as a minimum channel cross-sectional area between two adjacent blades is reduced especially on the shroud side. Accordingly, the flow velocity of the flow in the vicinity of the throat is increased, and choking easily occurs. When choking occurs, the operating range on the high flow rate side of the centrifugal compressor, i.e., the choke margin is narrowed.

On the other hand, as in the case of the patent literature 2, in the vicinity of the blade trailing edge of the impeller (in the vicinity of the impeller outlet), when the blade hub side is tilted such that it precedes the shroud side in the rotational direction of the impeller, the efficiency is improved as indicated in the non-patent literature 1, however, the operating range on the low flow rate side, i.e., the surge margin is narrowed.

The present invention has an object to obtain a gas pipeline centrifugal compressor in which the operating range on the low flow rate side can be expanded and the operating range on the high flow rate side can be maintained.

Another object of the present invention is to obtain a gas pipeline centrifugal compressor in which the operating range can be expanded and the efficiency can be improved while reduction of the efficiency can be suppressed.

Further object of the present invention is to obtain a gas pipeline to realize a compressor station provided with a high-efficient and low-price centrifugal compressor having a wide operating range.

### Solution to Problem

To attain the above-described object, the present invention provides a gas pipeline centrifugal compressor used in a gas pipeline having gas piping to transfer gas and a plurality of compressors for gas pressurization provided on a route of the gas piping, wherein the centrifugal compressor has a centrifugal impeller fastened to a shaft, and the centrifugal impeller has a hub and a plurality of blades provided at intervals in a circumferential direction of the hub, and wherein blade angle distribution of the blade is configured such that, when a hub side camber line connecting a hub side leading edge as a suction side end and a hub side trailing edge as a discharge side end of the blade is indicated with a lateral axis, and a hub side blade angle of the blade is indicated with a vertical axis, a hub side blade angle is maximum on a side closer to the hub side leading edge than a central point of the hub side camber line, and from a part where the blade angle is maximum to the hub side leading edge, a hub side blade angle distribution curve indicating the hub side blade angle distribution is convex in a blade angle increasing direction, and configured such that, when a counter-hub side camber line connecting a counter-hub side leading edge as a suction side end on a counter-hub side and a counter-hub side trailing edge as a discharge side end of the blade is indicated with the lateral axis and a counter-hub side blade angle of the blade is indicated with the vertical axis, the counter-hub side blade angle is minimum at the counter-hub side leading edge of the counter-hub side camber line, or on a side closer to the counter-hub side leading edge than a central point of the counter-hub side camber line, further configured such that, in an arbitrary section including a part where the blade angle is minimum in a counter-hub side blade angle distribution curve indicating the counter-hub side blade angle distribution, the counter-hub side blade angle distribution curve is convex in a small blade angle direction, and from a downstream side of the section where the counter-hub side blade angle distribution curve is convex to the counter-hub side trailing edge, the counter-hub side blade angle distribution curve is convex in a large blade angle direction.

Another characteristic feature of the present invention is a gas pipeline comprising: a gas piping to transfer gas from a gas source to a gas supply destination; a compressor station having a centrifugal compressor for gas pressurization set in a plurality of positions on a route of the gas piping; a pressure regulator and a flow rate measurement unit provided between the compressor stations provided in the plurality of positions; a valve system provided in the gas piping between a most upstream compressor station in the plurality of compressor stations and the gas source; and a controller that controls the valve system, the compressor stations, the pressure regulator and the flow rate measurement unit, wherein the centrifugal compressor for gas pressurization is the above-described gas pipeline centrifugal compressor.

### Advantageous Effects of Invention

According to the present invention, it is possible to obtain a gas pipeline centrifugal compressor in which the operating range on the low flow rate side can be expanded and the operating range on the high flow rate side can be maintained.

Further, it is possible to obtain a gas pipeline centrifugal compressor in which the operating range can be expanded and the efficiency can be improved while reduction of the efficiency can be suppressed.

Further, it is possible to obtain a gas pipeline to realize a compressor station provided with a high-efficient and low-price centrifugal compressor having a wide operating range.

### BRIEF DESCRIPTION OF THE DRAWINGS

FIG. 1 is a line graph showing a blade angle distribution of a centrifugal impeller in an embodiment 1 of a gas pipeline centrifugal compressor according to the present invention;

FIG. 2 is an axial directional view of a blade of the centrifugal impeller having the blade angle distribution shown in FIG. 1;

FIG. 3A is an explanatory diagram of the definition of the shape of the centrifugal impeller;

FIG. 3B is an explanatory diagram of a velocity triangle of the flow in the centrifugal impeller;

FIG. 4 is a line graph showing the blade angle distribution of the centrifugal impeller in an embodiment 2 of the gas pipeline centrifugal compressor according to the present invention;

FIG. 5 is an axial directional view of the blade of the centrifugal impeller having the blade angle distribution shown in FIG. 4;

FIG. 6 is an explanatory diagram of the definition of the blade shape in the axial directional view of the centrifugal impeller; FIG. 7 is an explanatory diagram of the blade shape of the centrifugal impeller in an embodiment 3 of the gas pipeline centrifugal compressor according to the present invention;

FIG. 8A is an explanatory diagram of the flow between two adjacent blades in the centrifugal impeller;

FIG. 8B is an explanatory diagram of the flow between the two adjacent blades in other centrifugal impeller than that in FIG. 8A;

FIG. 9 is a line graph showing the blade angle distribution of the centrifugal impeller in an embodiment 4 of the gas pipeline centrifugal compressor according to the present invention;

FIG. 10 is a meridional cross-sectional diagram showing an example of the gas pipeline centrifugal compressor according to the present invention;

FIG. 11 is an enlarged meridional cross-sectional diagram of a part of the centrifugal compressor shown in FIG. 10;

FIG. 12 is a schematic diagram showing an example of the gas pipeline in the present invention; and

FIG. 13 is a line graph showing the relation between a flow rate and a head in the centrifugal compressor.

### DESCRIPTION OF THE PREFERRED EMBODIMENTS

Hereinbelow, particular embodiments of the present invention will be described based on the drawings. Note that in the respective drawings, elements having the same reference numerals indicate the same or corresponding elements.

### Embodiment 1

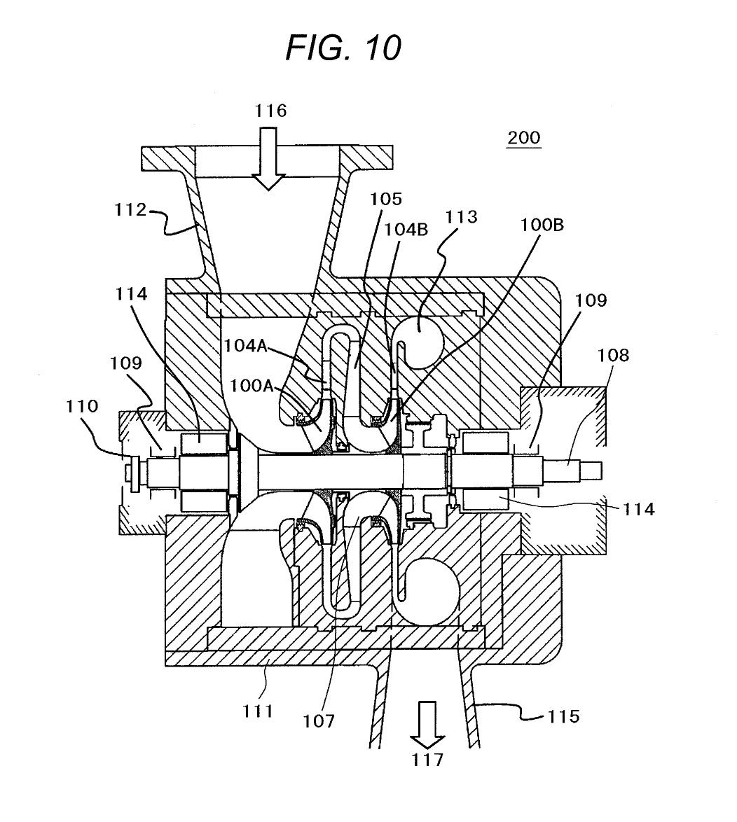

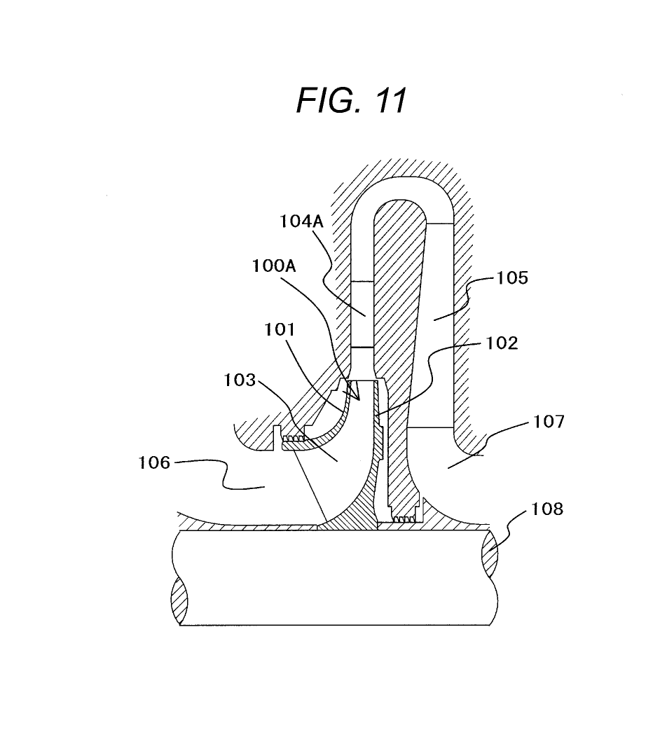

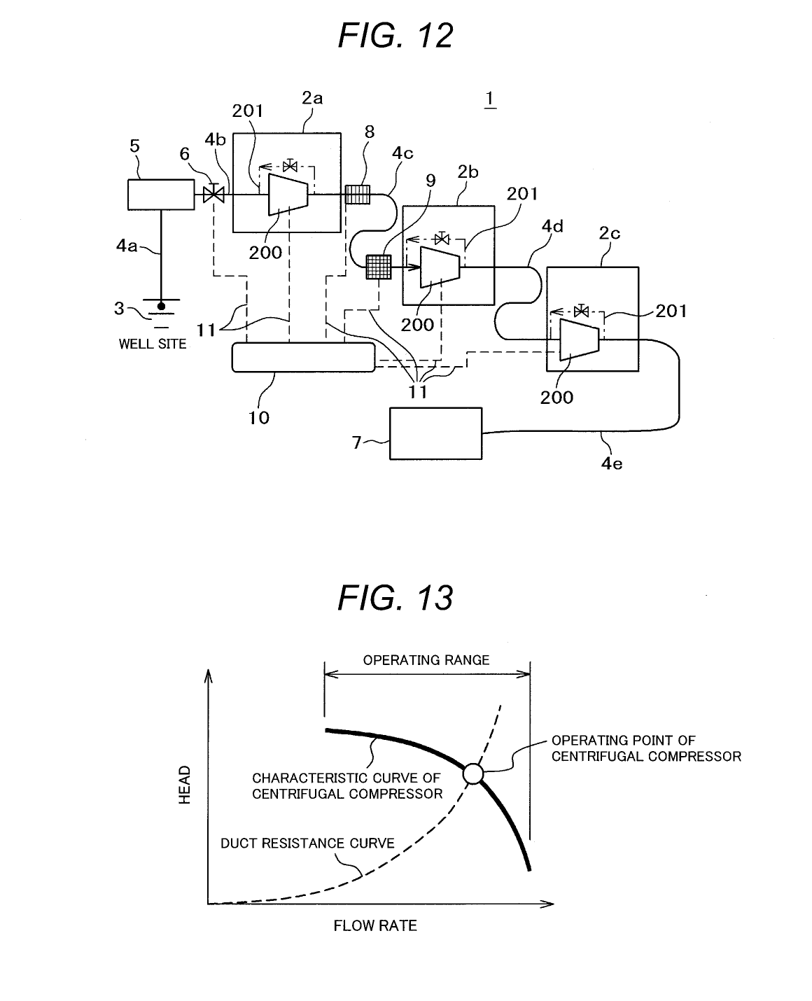

First, the configuration of a gas pipeline centrifugal compressor and the configuration of a gas pipe line will be described in accordance with FIGS. 10 to 13. FIG. 10 is a meridional cross-sectional diagram showing an example of the gas pipeline centrifugal compressor according to the present invention. FIG. 11 is an enlarged meridional cross-sectional diagram showing a part (in the vicinity of a first stage impeller) of the centrifugal compressor shown in FIG. 10. FIG. 12 is a schematic diagram showing an example of the gas pipeline according to the present invention. FIG. 13 is a line graph showing the relation between a flow rate and a head in the centrifugal compressor.

FIG. 13 shows a characteristic curve of the centrifugal compressor. In FIG. 13, the lateral axis indicates a flow rate, and a vertical axis, a head. In the characteristic curve of a general centrifugal compressor, as indicated with a solid line in FIG. 13, an operating point at which the centrifugal compressor is actually activated is an intersection point between a duct resistance curve and the characteristic curve of the centrifugal compressor.

The system configuration of the gas pipeline will be described with the schematic diagram of FIG. 12. In the example shown in FIG. 12, a compressor station 2 (2a, 2b, 2c) is provided in three positions on the route of a gas piping 4 (4a, 4b, 4c, 4d, 4e) of a gas pipeline 1.

Gas is sent from a natural gas well site (gas source) 3 such as an oil field or a gas field, via a gas piping 4a, first to a gas processing facility 5, in which the gas is subjected to processing such as gas gathering or gas treatment, then is sent via a valve system (including a valve) 6 and a gas piping 4b, to a first compressor station 2a. The compressor station 2a has a centrifugal compressor (gas pipeline centrifugal compressor) 200 for gas pressurization, a bypass piping system 201 and the like. Next, the gas pressurized with the first compressor station 2a is sent via a gas piping 4c to a second compressor station 2b, and further, sent via a gas piping 4d to a third compressor station 2c. These second and third compressor stations 2b and 2c also have the same configuration as that of the first compressor station 2a.

The gas pressurized with the third compressor station 2c is sent through a gas piping 4e to each of various plants (gas supply destinations) 7 such as an LNG plant. The gas piping 4c on the downstream side of the first compressor station 2a is provided with a pressure regulator 8, a flow rate measurement unit 9 and the like. Reference numeral 10 denotes a controller to control the respective compressor stations 2a, 2b and 2c, the valve system 6, the pressure regulator 8, the flow rate measurement unit 9 and the like, via a control signal transmitter (control line) 11.

The compressor station (2a, 2b, 2c) shown in FIG. 12 is provided by, e.g., several 10 km. Accordingly, the resistance curve of the pipeline centrifugal compressor 200 depends on the duct resistance (loss) of this long gas piping. The specification of the gas pipeline centrifugal compressor 200 is determined based on the prediction of the duct resistance. When the predictive accuracy regarding the duct resistance of the duct having the long gas piping is insufficient, the resistance curve in FIG. 13, i.e., the flow rate at the operating point of the centrifugal compressor varies. However, when the operating range of the centrifugal compressor is sufficiently wide, it is possible to perform operation corresponding to the variation.

Further, when the amount of gas gathered from the well site 3 is reduced, the flow rate also changes. In such case, in the conventional centrifugal compressor with a narrow operating range, it is impossible to continue the operation in some cases. Accordingly, in this case, a part of the compressed gas is returned with the bypass piping system 201 to the suction side of the centrifugal compressor 200, thus a circulation channel is formed. With this arrangement, operation on the high flow rate side is possible in the centrifugal compressor 200. However, when this operation is performed, as a part of the compressed gas is returned with the bypass piping system 201 to the suction side, operation to send a low rate gas to the downstream side is performed in the first compressor station 2. At this time, as high flow rate operation is performed in the centrifugal compressor 200, the motive power is wasted.

Then, when the centrifugal compressor 200 having a wide operating range is realized, it is possible to perform long-term operation of the gas pipeline centrifugal compressor 200 without bypass operation with the bypass piping system 201. In the gas pipeline centrifugal compressor 200 in the present embodiment, as described later, the operating range can be wide. Accordingly, it is possible to perform long-term operation without the bypass piping system 201 even when the amount of gas at the well site 3 is reduced, by adopting the gas pipeline centrifugal compressor 200 in the present embodiment as a centrifugal compressor for gas pressurization in the first compressor station 2. Accordingly, it is possible to obtain an efficient gas pipeline where waste of power consumption is suppressed.

Next, using FIG. 10 and FIG. 11, an example of the centrifugal compressor 200 adopted in a gas pipeline shown in FIG. 12 will be described.

FIG. 10 shows the entire configuration of the gas pipeline centrifugal compressor 200. The centrifugal compressor 200 is a uniaxial multistage centrifugal compressor in which a single shaft 108 is provided with a multistage (two stages in this example) centrifugal impeller (hereinbelow, it may be simply referred to as an “impeller”) 100 (100A and 100B).

The centrifugal impeller 100 (100A and 100B) rotates integrally with the shaft 108, to apply the rotational energy to fluid.

The shaft 108 is rotatably supported with radial bearings 109 provided at both ends of the shaft 108. Further, a thrust bearing 110 to support the shaft 108 in an axial direction is provided at one end of the shaft 108. Further, a seal 114 is respectively provided inside of the radial bearings 109 at both ends of the shaft 108.

A diffuser 104 (104A, 104B) to convert the dynamic pressure of the fluid made to flow from the centrifugal impeller 100 to static pressure is provided outside of the centrifugal impeller 100A, 100B in the radial direction. A return channel 105 to lead the fluid to a downstream channel 107 is provided downstream of the diffuser 104A. The gas is led from the downstream channel 107 to the subsequent stage centrifugal impeller 100B.

The impellers 100A and 100B, the diffusers 104A and 104B and the return channel 105 are accommodated in a casing 111. Further, a suction casing 112 is provided on the suction side of the casing 111. A discharge casing 115 is provided on the discharge side of the casing 111.

The gas (fluid) sucked from the suction casing 112 as indicated with an arrow 116 is sucked from a suction port of the initial stage impeller 100A, then it is pressurized while it is made to pass through the impeller 100A, the diffuser 104A and the return channel 105, and sent to the subsequent stage impeller 100B. Further, the gas made to flow from the subsequent stage centrifugal impeller 100B is made to pass through the diffuser 104B, then is made to pass through a scroll 113, then finally it is pressurized to have predetermined pressure and discharged to the outside from the discharge casing 115 as indicated with an arrow 117.

FIG. 11 shows an enlarged view around the initial stage (first stage) impeller 100A in FIG. 10. The configuration of the initial stage impeller 100A will be described using FIG. 11.

The impeller 100A has a disk-shaped hub 102 fastened to the shaft 108, a shroud (side plate) 101 provided oppositely to the hub 102, and plural blades 103, positioned between the hub 102 and the shroud 101, provided at intervals in a circumferential direction. Note that the subsequent stage (second stage) impeller 100B (see FIG. 10) has the same configuration as that of the initial stage impeller 100A. Further, the impeller 100 shown in FIG. 11 has the shroud 101, however, it maybe a so-called half shroud type impeller which does not have the shroud 101.

Further, in the present embodiment, as the diffuser 104A, a vaned diffuser having plural vanes in the circumferential direction is adopted. The subsequent stage diffuser 104B (see FIG. 10) has the same configuration. Note that a vaneless diffuser which does not have any vane may be used.

Note that numeral 106 denotes the above-described suction port of the initial stage impeller 100A; and 107, the above-described downstream channel.

In the centrifugal compressor 200, especially in a centrifugal compressor to handle gaseous matter, a phenomenon that the flow is stalled in the centrifugal impeller 100 and the diffuser 104 in accordance with reduction of flow rate, and even when the flow rate is reduced by using a flow rate regulating valve or the like, the pressure is not raised from that level, and a large pressure variation and flow rate variation are caused occurs. This phenomenon is surge (or surging), which indicates a limiting point on the low flow rate side of the centrifugal compressor 200.

On the other hand, when the flow rate regulating valve or the like is opened so as to increase the flow rate from the surge-occurred limiting flow rate, a phenomenon that the discharge pressure is lowered and the flow rate is not increased from that level occurs. This phenomenon is called choking, which indicates a limiting point on the high flow rate side of the centrifugal compressor 200. The section between these two limiting points, surge and choking, is called an operating range of the centrifugal compressor. It is required that the operating range is expanded without lowering the efficiency of the centrifugal compressor.

Hereinbelow, the centrifugal compressor 200 in which the operating range can be expanded without lowering the efficiency will be described.

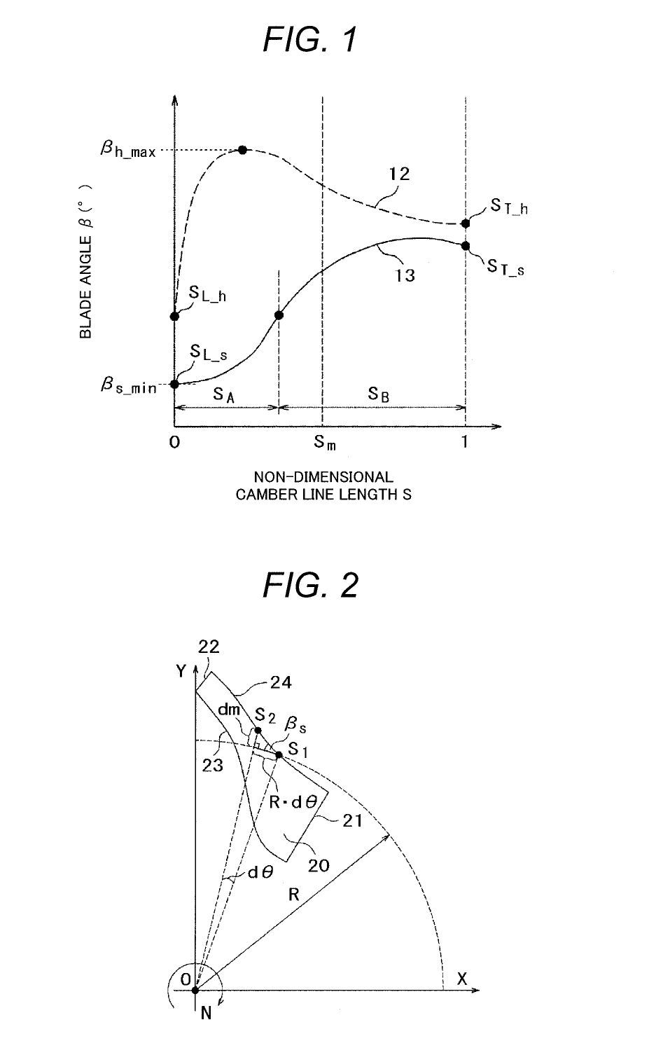

Using FIGS. 1 to 3, an embodiment 1 of the gas pipeline centrifugal compressor 200 used in the gas pipeline according to the present invention will be described. Note that in the following description, a centrifugal impeller having a shroud will be described, however, a half-shroud type centrifugal impeller without shroud is also applicable. In the case of the half-shroud type centrifugal impeller, the “shroud side” in the following description is a “counter-hub side”. Further, in the case of the centrifugal impeller having a shroud, the “counter-hub side” means the “shroud side”.

FIG. 1 is a line graph showing the blade angle distribution of one blade 20 (see FIG. 2) among the blades 103 in the centrifugal impeller 100 of the gas pipeline centrifugal compressor 200. In FIG. 1, the lateral axis indicates a non-dimensional blade center line (camber line) S plotted by connecting points, where the distances from pressure surface and suction surface of the blade 20 are equal, with regard to hub side end and shroud side (counter-hub side) end. Further, the vertical axis in FIG. 1 indicates a blade angle β (°).

Numeral 12 denotes a hub side blade angle distribution curve showing the blade angle distribution on the hub side; and 13, a shroud side (counter-hub side) blade angle distribution curve showing the blade angle distribution on the shroud side (counter-hub side). In the lateral axis in FIG. 1, the total camber line length from the leading edge side to the trailing edge side in the respective curves 12 and 13 is 1, i.e., the leading edge side of the blade 20 is expressed as “S=0” while the trailing edge side of the blade 20, “S=1”. In the figure, Sₘ denotes an intermediate point (S=0.5).

The distribution of the blade angle β at the hub side end of the blade 20 is as shown with the hub-side blade angle distribution curve 12 as a broken line. Further, the distribution of the blade angle β at the shroud side end of the blade 20 is as shown with the shroud-side blade angle distribution curve 13 as a solid line.

FIG. 2 is an axial directional view of one blade 20 among the blades 103 in the centrifugal impeller 100. The hub side end of the blade 20 is indicated with a curve 23, while the shroud side end of the blade 20, with a curve 24. Note that in the description of FIG. 2 and the subsequent description, the camber line is used as a representative curve of the blade 20. A leading edge 21 as a suction side end and a trailing edge 22 as a discharge side end of the blade 20 in the centrifugal impeller 100 are respectively linear shaped.

The blade angle β is expressed as inclination from the circumferential direction. For example, the blade angle βₛ in the position of the radius R on the shroud side is expressed as a ratio between a circumferential minute length R·dθ and a distance dm on a meridian plane. The distance dm on the meridian plane is a distance between points obtained by, assuming that the shroud side end 24 has changed from a point s₁ to a point s₂, projecting the points s₁ and s₂ on a meridian plane of the impeller 100 (R-Z plane) (R: radial coordinate, Z: axial coordinate) in the circumferential minute length R·dθ on the blade 20. Accordingly, the blade angle β on the camber line between the points s₁ and s₂ is indicated with the following expression (1). Note that in FIG. 2, N denotes a rotational direction; and O, an origin.

B=tan⁻¹(dm/(R·dθ)) (1)

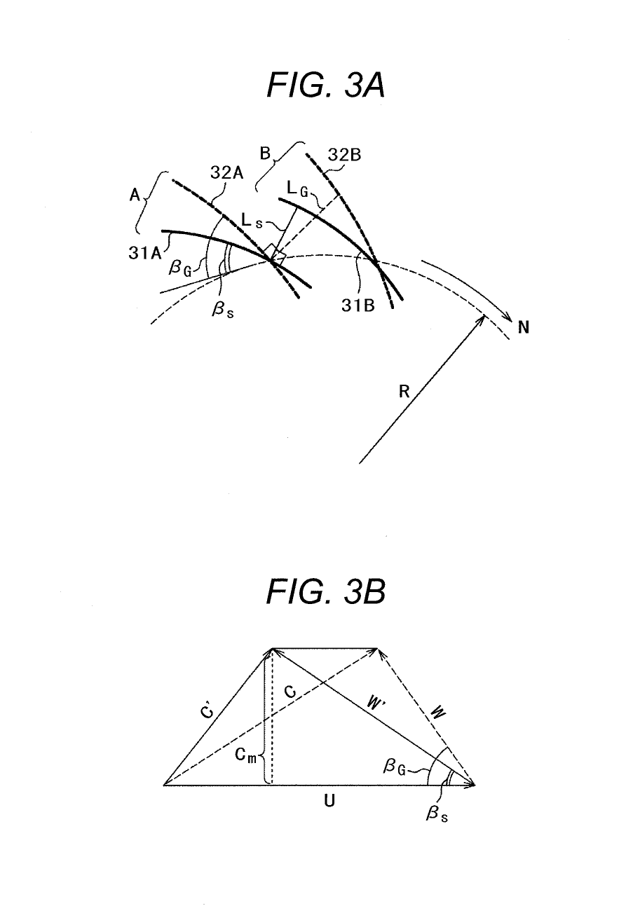

FIG. 3A is an axial perspective diagram of two adjacent blades A and B in an arbitrary radial positions. A broken line indicates a case where the blade angle β is large and β=β_{G} holds, and solid line, a case where the blade angle β is small and β=βₛ holds. The suction surfaces of the blades A and B are denoted by numerals 31A and 31B, and the pressure surfaces, by numerals 32A and 32B. A perpendicular line drawn from the blade A of the two adjacent blades A and B onto the suction surface of the other blade B is a blade passage width L. The blade passage width L is L_{G} when blade angle β=β_{G} holds, and is Lₛ when blade angle β=βₛ holds.

FIG. 3B is a vector diagram showing a velocity triangle of the flow in the impeller 100. When the circumferential velocity of the impeller 100 is U and the blade angle β is β_{G}, a relative velocity of the flow in the impeller 100 is W, and an absolute velocity of the flow in the impeller 100 is C. When the blade angle β is βₛ, the relative velocity of the flow in the impeller 100 is W′, and the absolute velocity of the flow in the impeller 100 is C′. Cₘ is a meridional component of the absolute velocity and is a velocity component related to the flow rate.

Returning to FIG. 1, the shroud-side blade angle distribution curve 13 showing the distribution of the shroud side blade angle βₛ of the blade 20 takes a minimum value βₛ_{_}ₘᵢₙ at a blade leading edge S_{L}_{_}ₛ, and is increased toward the downstream side. The shroud-side blade angle distribution curve 13 is downwardly convex within the range of the camber line length S_{A} from the blade leading edge S_{L}_{_}ₛ, and is upwardly convex within the range of the camber line length S_{B} from the point of the camber line length S_{A} to the blade trailing edge S_{T}_{_}ₛ. Note that the camber line length S_{A} is smaller than the flow-directional intermediate point Sₘ (non-dimensional camber line length S=0.5).

That is, in an arbitrary section including a part (βₛ_{_}ₘᵢₙ) where the blade angle βₛ in the shroud-side blade angle distribution curve 13 is minimum, the shroud-side blade angle distribution curve 13 is convex in a small blade angle direction, and in a section from the downstream side of the section S_{A} to the shroud side trailing edge, the shroud-side blade angle distribution curve 13 is convex in a large blade angle direction.

On the other hand, the hub-side blade angle distribution curve 12 showing the distribution of the hub side blade angle βₕ forms maximum blade angle βₕ_{_}ₘₐₓ between a blade leading edge S_{L}_{_}ₕ and the flow-directional intermediate point Sₘ (non-dimensional camber line length S=0.5). From the maximum blade angle part (βₕ_{_}ₘₐₓ) to the hub side leading edge, the hub side blade angle distribution curve showing the distribution of the hub side blade angle is convex in the blade angle increasing direction. Between the blade leading edge S_{L}_{_}ₕ and the blade angle βₕ_{_}ₘₐₓ, the distribution curve 12 showing the hub-side blade angle βₕ has no inflection point.

The ground of the setting of the shape of the blade 20 in this manner is as follows.

In FIG. 3A, the difference between the blade angle β_{G} and βₛ appears as a difference in the shape of the velocity triangle in FIG. 3B. When the meridional components Cₘ of the absolute velocities C, C′ in FIG. 3B are approximately the same in the same radial position, the relative velocity vector W′ in the case of βₛ when the blade angle β is small is larger than the relative velocity vector W in the case of β_{G} when the blade angle β is large.

In the general centrifugal impeller 100, the deceleration of the shroud-side relative flow velocity is higher than that of the hub-side relative flow velocity. Accordingly, it is possible to improve the impeller efficiency and the impeller stall characteristic determined based on the values of wall friction loss, deceleration loss (loss due to increase in thickness of wall boundary layer toward the downstream side in the flow direction by deceleration of the relative flow velocity) and the like by appropriately setting the deceleration of the relative flow velocity on the shroud side.

Accordingly, in the present embodiment, the distribution is set such that the shroud side blade angle βₛ is minimum at the blade leading edge, and in the section of the camber line length S_{A}, the blade angle distribution curve 13 is downwardly convex. With this arrangement, it is possible to suppress increase of the blade angle βₛ in the first half on the shroud side where the deceleration of the relative flow velocity is large and the blade 20 is easily stalled, and to reduce the deceleration of the relative flow velocity. Accordingly, it is possible to suppress the stall of the impeller to the further low flow rate side.

Further, when it is arranged such that the relative flow velocity is not decelerated on the shroud-side leading edge side (in the camber line length S_{A}) of the blade 20, a high relative flow-velocity region is expanded from the blade leading edge 21 toward the flow direction downstream side. In the high relative flow-velocity region, the wall friction loss is large, and the increase of the high relative flow-velocity region causes reduction of the impeller efficiency. According to the present embodiment, in the distribution on the shroud-side blade trailing edge 22 side (within the camber line length S_{B}), the blade angle βₛ is upwardly convex, to decelerate the relative flow velocity so as to prevent increase of the wall friction loss.

That is, in the shroud-side blade leading edge side (within the camber line length S_{A}), the increase of the blade angle βₛ in the vicinity of the leading edge 21 is suppressed, and thereafter, the blade angle βₛ is radically increased so as to increase the deceleration of the relative flow velocity. That is, in the region where the increase of the blade angle βₛ is suppressed, the relative flow velocity becomes high as shown in FIG. 3B, and this high relative flow-velocity region is expanded to the downstream side. As a result, the impeller stall on the low flow rate side due to relative flow velocity reduction is suppressed, and it is possible to improve the impeller efficiency.

In the impeller in the present embodiment, since the increase of the blade angle βₛ on the shroud-side leading edge side (within the range of the camber line length S_{A}) is suppressed, the blade passage width L is narrowed as shown in FIG. 3A on the shroud-side leading edge side (within the range of the camber line length S_{A}). Regarding the camber line length S direction, the blade passage width L is minimum at the blade leading edge 21, and further, is smaller on the shroud 23 side than that on the hub 24 side.

In the blade passage formed with the two adjacent blades A and B, regarding the direction of the camber line length S, a part where the channel cross sectional area is minimum is called a “throat”. In this throat, when the Mach number of the relative flow velocity exceeds 1, choking occurs and it is impossible to increase the flow rate. Accordingly, in high flow rate operation in the centrifugal compressor where the relative flow velocity is increased, the operating range is narrowed.

In the present embodiment, to avoid this inconvenience, it is arranged such that the hub side blade angle βₕ is maximum (βₕ_{_}ₘₐₓ) from the blade leading edge (non-dimensional camber line length S=0) to the point where the non-dimensional camber line length S=Sₘ=0.5 holds. Further, from the part where the blade angle is maximum to the hub side leading edge, the curve indicating the hub-side blade angle distribution (hub-side blade angle distribution curve 12) is convex in the blade angle increasing direction. Further, in the section from the blade leading edge 21 to the point where the blade angle βₕ is maximum (the section where the hub-side blade angle distribution curve 12 is convex in the blade angle increasing direction), the distribution curve 12 of the hub-side blade angle βₕ has no inflection point.

With this arrangement, the hub side blade angle βₕ is increased smoothly and radically between the throat, often formed until the non-dimensional camber line length S=0.5 holds, and the blade leading edge 21 (non-dimensional camber line length S=0). As a result, the hub side blade angle βₕ_{_}ₜₕᵣₒₐₜ in the throat is increased, and in the throat, a blade passage width Lₕ is increased in the vicinity of the hub side. Accordingly, even when a blade passage width Lₛ is narrowed on the shroud side, as the blade passage width Lₕ is increased in the vicinity of the hub side, the area of the throat can be maintained. Since the hub side blade angle distribution has no inflection point and is upwardly convex, the increase of the hub-side blade passage width Lₕ is realized. As a result, it is possible to expand the flow rate region where the Mach number of the relative flow velocity exceeds 1 to the further high flow-rate side, to suppress the occurrence of choking in the impeller 100, and to ensure the high flow-rate side operating range in the centrifugal compressor.

Note that to increase the hub side blade angle βₕ in the throat, the hub-side blade angle maximum value βₕ_{_}ₘₐₓ is brought closer to 90° as much as possible within a range where separation of the hub side surface of the blade 20 does not occur. In this manner, when the hub-side blade angle maximum value βₕ_{_}ₘₐₓ is brought closer to 90°, the hub-side blade angle maximum value βₕ_{_}ₘₐₓ is often greater than a hub-side outlet blade angle βₕ_{_}_{T}. Accordingly, it is desirable that the blade angle βₕ distribution from the point where the hub side blade angle is the maximum value βₕ_{_}ₘₐₓ to the hub side outlet is smoothly reduced.

### Embodiment 2

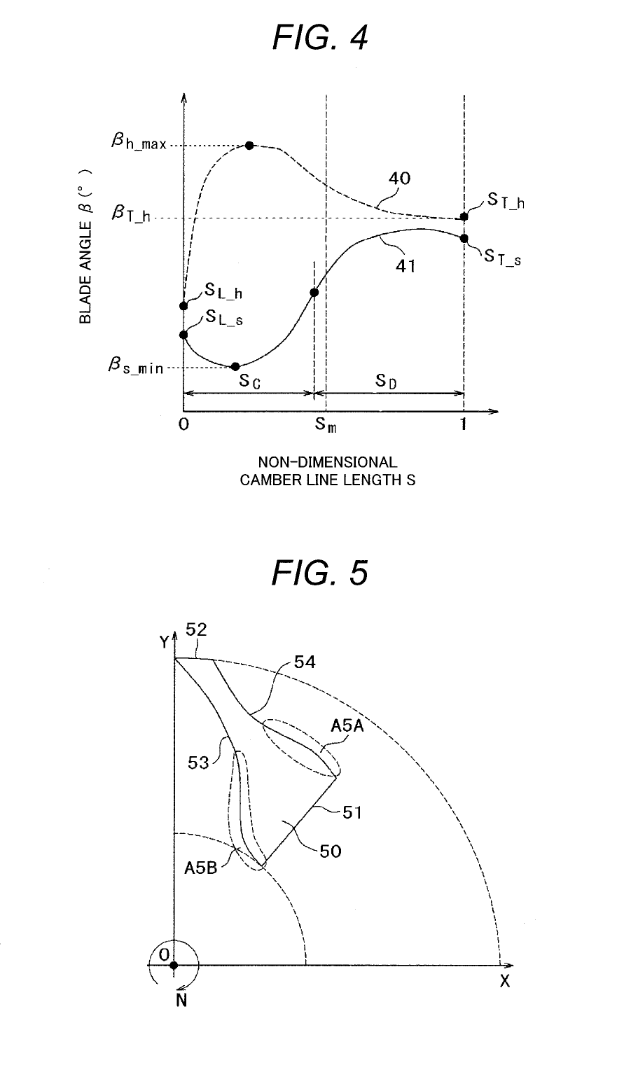

An embodiment 2 of the centrifugal compressor 200 of the present invention will be described using FIGS. 4 to 6. In the present embodiment, the difference from the centrifugal compressor shown in the above-described embodiment 1 is that the position of the minimum value in the shroud-side blade angle distribution of the blade of the centrifugal impeller 100 is changed.

FIG. 4 shows an example of the blade angle distribution of the centrifugal impeller 100 according to the present embodiment. A hub-side blade angle distribution curve 40 is similar to that in the embodiment 1. On the other hand, a shroud-side blade angle distribution curve 41 as the counter-hub side is once reduced from the blade leading edge S_{L}_{_}ₛ toward the flow direction downstream side, then takes a minimum value βₛ_{_}ₘᵢₙ in a position closer to the shroud side leading edge than the intermediate point Sₘ (camber line length S=0.5), then is increased thereafter. Further, the blade angle between the shroud-side blade leading edge S_{L}_{_}ₛ and the blade trailing edge S_{T}_{_}ₛ is downwardly convex initially, and then upwardly convex around the end, along the camber line in the downstream direction.

In FIG. 4, the blade angle distribution curve 41 is downwardly convex in a section S_{c} on the upstream side from the intermediate point Sₘ and is upwardly convex in a section S_{D} following the section S_{c}. In the section S_{c}, in which the blade angle is downwardly convex may exceed the intermediate point Sₘ.

In the centrifugal impeller 100 having the above arrangement shown in the embodiment 2, it is possible to further reduce the deceleration of the relative flow velocity in the vicinity of the shroud side leading edge of the impeller 100 in comparison with the centrifugal impeller 100 shown in the above-described embodiment 1. With this arrangement, it is possible to obtain a centrifugal impeller in which the operating range on the low flow rate side is further expanded.

Note that in the embodiment 2, the blade passage width L is further smaller on the shroud side of the throat in comparison with the impeller shown in the above-described embodiment 1. Accordingly, in the present embodiment, to ensure the operating range of the centrifugal impeller 100 on the high flow-rate side, the hub-side maximum blade angle βₕ_{_}ₘₐₓ is equal to or greater than that in the embodiment 1. Further, as the hub-side maximum blade angle Bₕ_{_}ₘₐₓ is often wider than the hub-side outlet blade angle β_{T}_{_}ₕ, the distribution is set such that the blade angle is smoothly reduced from the position of the hub-side maximum blade angle βₕ_{_}ₘₐₓ to the hub-side outlet S_{T}_{_}ₕ.

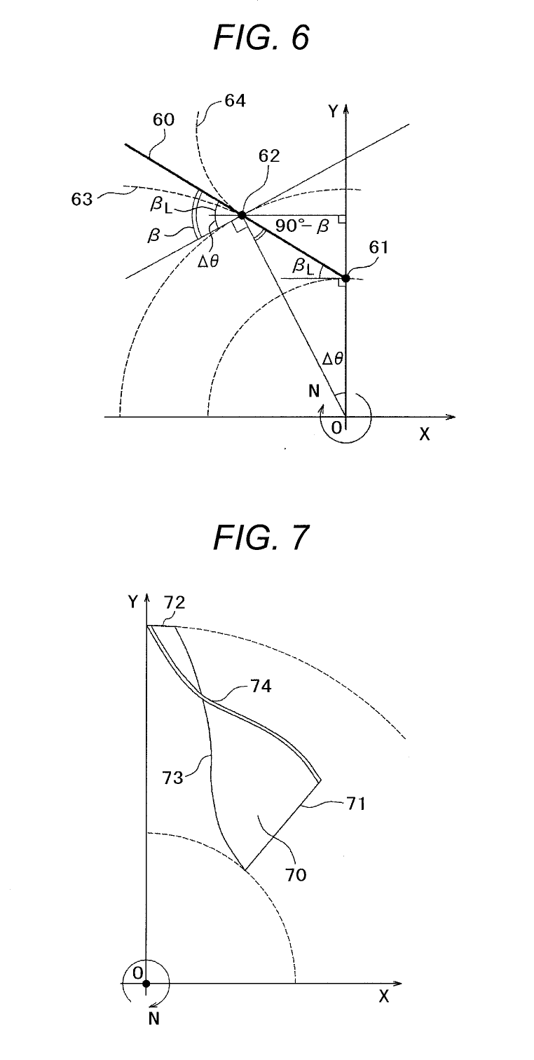

FIG. 5 is an axial directional view of one blade 50 of the centrifugal impeller having the blade angle distribution shown in FIG. 4. A shroud side camber line 54 of the blade 50 has an approximately S shape having a part A5A the blade leading edge 51 side of which is radial outwardly convex (outer diameter side). On the other hand, a hub side camber line 53 of the blade 50 has an approximately S shape having a part A5B the blade leading edge 51 side of which is radial inwardly convex (inner diameter side). The grounds will be described also using FIG. 6.

FIG. 6 is a coordinate system and an axial directional view regarding the centrifugal impeller 100. FIG. 6 is a diagram viewed from the suction side. The centrifugal impeller 100 rotates about a shaft O in a rotational direction N. To assist explanation of the operation of the blade of the centrifugal impeller 100, a blade 60 having a linear blade camber line will be described.

The figure shows that, assuming that the blade angle at a blade leading edge 61 is β_{L}, the blade angle β is in a position 62 on the downstream side from the blade leading edge 61. The position 62 is away from the blade leading edge 61 by Δθ in the circumferential direction. The blade angle β in the position 62 is represented from geometrical relation as β=β_{L}+Δθ.

In the blade where the blade camber line is linear shaped, the blade angle β is linearly increased with respect to a circumferential angle θ from the blade leading edge 61 toward the downstream side.

An example where the blade angle β is not linearly changed with respect to the circumferential angle θ of the blade camber line and the increase of the blade angle β is gradually reduced from the position 62 toward the downstream side, and another example where the increase of the blade angle β is increased, will be described. When the increase of the blade angle β is reduced with respect to the circumferential angle θ of the camber line from the position 62, the shape of the camber line is as indicated with a curve 63 in FIG. 6. That is, it is in contact with the linear camber line passing through the position 62, and is convex radial outwardly. On the other hand, when the increase of the blade angle β is radically increased with respect to the circumferential angle θ of the camber line, the shape of the camber line is as indicated with a curve 64 in FIG. 6. That is, it is in contact with the linear camber line passing through the position 62 and is convex radial inwardly.

In the centrifugal impeller 100 having the blade angle distribution shown in FIG. 4, the shroud-side blade angle distribution is once reduced from the blade leading edge toward the downstream side, to minimum, and is increased thereafter. Accordingly, as shown in FIG. 5, the shroud-side camber line shows an approximately S shape where the blade leading edge 51 side is convex radial outwardly. Further, as the hub-side blade angle distribution is maximum without inflection point from the leading edge 51 to the flow direction intermediate point, and is smoothly reduced on the downstream side from the position of the maximum value, the hub side camber line has an approximately S shape where the blade leading edge 51 side is convex radial inwardly. In this manner, the blade angle distribution shown in FIG. 4 has the above-described approximately S shape in appearance.

### Embodiment 3

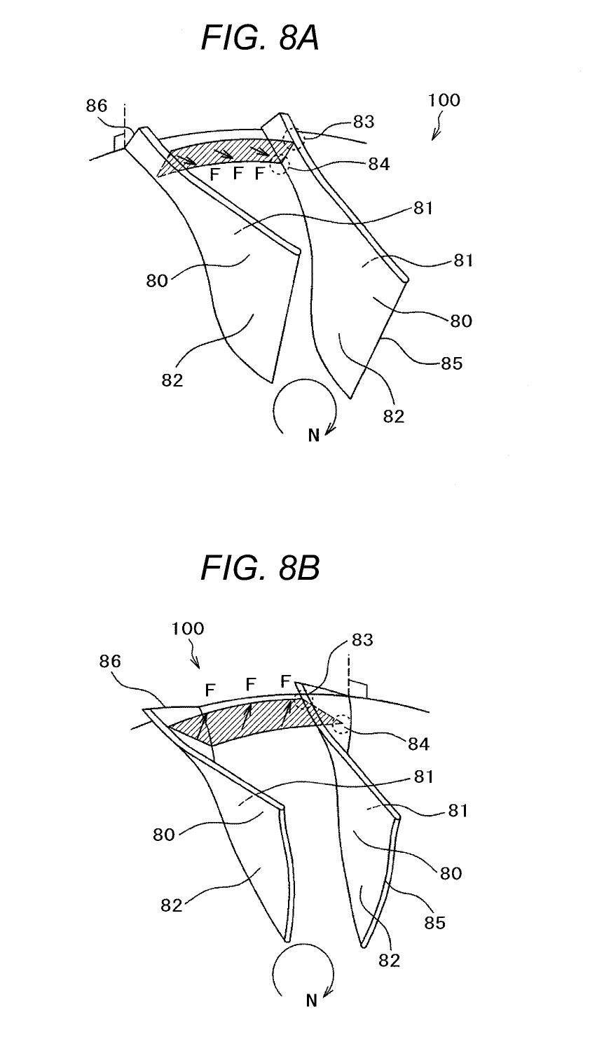

An embodiment 3 of the gas pipeline centrifugal compressor of the present invention will be described with reference to FIGS. 7 and 8. In the embodiment 3, the difference from the centrifugal compressor 200 shown in the above-described embodiments 1 and 2 is that, in the embodiment 3, in addition to the arrangement of the embodiments 1 and 2, the inclination direction at the blade trailing edge in the centrifugal impeller 100 is tilted backward with respect to the rotational direction. With this arrangement, as shown in FIG. 7, when the centrifugal impeller 100 is viewed from the axial direction, a hub side camber line 73 and a shroud side camber line 74 of a blade 70 intersect each other.

That is, FIG. 7 is an axial directional view of the one blade 70 among the blades 103 (see FIG. 11) in the centrifugal impeller 100. On the blade trailing edge 72 side of the blade 70, the trailing edge of the shroud side camber line 74 is positioned on the rear side than the trailing edge of the hub side camber line 73 with respect to the rotational direction (N direction in the figure). Note that the blade angle distribution of the hub side camber line 73 and that of the shroud side camber line 74 are similar to that in the above-described embodiment 1 or the embodiment 2.

The operation of the centrifugal impeller 100 in the embodiment 3 having the above-described arrangement will be described below using FIGS. 8A and 8B. In these figures, the blade of the centrifugal impeller 100 is denoted by numeral 80.

FIG. 8A is a diagram of the impeller 100 in which the camber line on the shroud side 83 of the blade 80 is tilted frontward from the camber line on the hub side 84 on the trailing edge 86 side of the blade 80 (hereinbelow, also referred to as a “forward tilted impeller”), and a diagram of two adjacent blades 80 forming the blade passage. As shown in FIG. 8A, at the trailing edge 86 of the blade 80, when the shroud side 83 of the blade 80 is tilted forward from the hub side 84 with respect to the rotational direction, it is possible to reduce the centrifugal force acting on the blade 80.

On the other hand, regarding the inner flow, a blade force F acting from each blade 80 to the fluid acts in a vertical direction with respect to the blade pressure surface 81, in other words, the direction of the hub side 84 of the blade suction surface 82. As the static pressure is raised in the direction where the blade force F acts, the static pressure is raised on the hub side 84 of the blade suction surface 82. On the other hand, the static pressure is lowered on the shroud side 83 of the blade suction surface 82.

In the blade passage of the centrifugal impeller 100, a wall velocity boundary layer where the flow velocity is lower than the main flow velocity and the energy is low occurs in the vicinity of the wall surface. The fluid in the wall velocity boundary layer cannot overcome the gradient of the static pressure in the blade passage cross section, and it drifts from a high static pressure region to a low static pressure region. Note that the blade passage cross section is a cross section obtained by cutting the blade passage in a radius r=predetermined cylindrical surface from the center of the shaft. The drifting flow forms a secondary flow having a flow velocity component in the vertical direction with respect to the main flow in the blade passage cross section.

As described above, the secondary flow from the blade pressure surface 81 having high static pressure toward the blade suction surface 82 having low static pressure occurs in the vicinity of the wall velocity boundary layer in the blade passage cross section of the centrifugal impeller 100. Further, in the forward-tilted impeller, a secondary flow from the hub side 84 to the shroud side 83 also occurs in the vicinity of the wall velocity boundary layer of the blade suction surface 82. Accordingly, the low energy fluid is accumulated on the shroud side 83 of the blade suction surface 82, and the pressure loss is increased. In addition, the uniformity of the flow in the blade passage cross section is degraded, and the loss in the diffuser and the return channel on the downstream side from the impeller 100 is increased.

Note that in FIG. 8A, numeral 85 denotes the blade 80 leading edge.

FIG. 8B is a diagram of the impeller 100 in which the camber line on the shroud side 83 is tilted further backward than the camber line on the hub side 84, on the blade trailing edge 86 side (hereinbelow, also referred to as a “backward-tilted impeller”), and a graph showing the two adjacent blades 80 forming the blade passage. In the backward-tilted impeller, the blade force F acts in the direction of the shroud side 83 of the blade suction surface 82. Accordingly, on the hub side 84 of the blade suction surface 82, the static pressure is lowered, while on the shroud side 83 of the blade suction surface 82, the static pressure is raised. With this arrangement, it is possible to suppress the secondary flow toward the shroud side 83 of the blade suction surface 82. The uniformity of the flow in blade passage cross section is improved, and the efficiency of the centrifugal impeller 100 is improved. That is, it is possible to realize an impeller with higher efficiency and wide operating range by combining the backward-tilted impeller and the blade angle distribution according to the embodiment 1 or 2.

Further, it is possible to obtain a gas pipeline centrifugal compressor with higher efficiency and a wider operating range in comparison with conventional devices by applying the above impeller to a gas pipeline centrifugal compressor.

### Embodiment 4

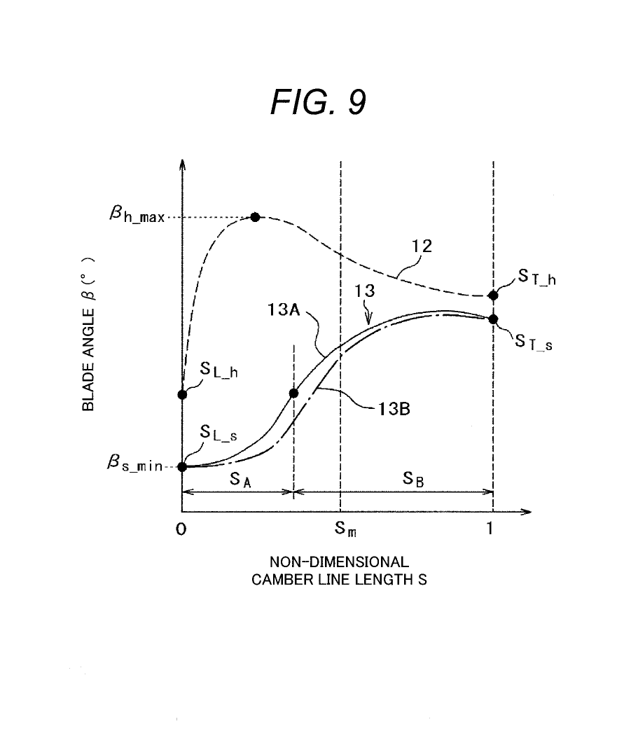

Using FIG. 9 and the above-described FIG. 10, an embodiment 4 of the gas pipeline centrifugal compressor according to the present invention will be described. The embodiment 4 is advantageous when the present invention is applied to a uniaxial multistage centrifugal compressor as shown in FIG. 10 (two stage device in FIG. 10). FIG. 9 corresponds to FIG. 1 in the above-described embodiment 1. As in the case of FIG. 1, FIG. 9 illustrates the hub-side blade angle distribution curve 12 and the shroud-side blade angle distribution curve 13. The hub-side blade angle distribution curve 12 shown in FIG. 9 is similar to the hub-side blade angle distribution curve 12 in FIG. 1.

In the present embodiment, as shown in FIG. 9, as the shroud side (counter-hub side) blade angle distribution curve 13, two types of distribution curves, i.e., a shroud-side (counter-hub side) blade angle distribution curve 13A of an upstream stage impeller indicated with a solid line, and a shroud-side (counter-hub side) blade angle distribution curve 13B of a downstream stage impeller indicated with an alternate long and short dash line, are shown.

The shroud-side blade angle distribution curve 13A of the upstream stage impeller indicated with the solid line corresponds to the blade angle distribution in the initial stage (first stage) centrifugal impeller 100A of the two stage centrifugal compressor shown in FIG. 10. The shroud-side blade angle distribution curve 13B indicated with the alternate long and short dash line corresponds to the blade angle distribution in the subsequent stage (second stage) centrifugal impeller 100B shown in FIG. 10.

The shroud-side blade angle distribution curve 13B of the subsequent stage centrifugal impeller 100B indicated with the alternate long and short dash line is set such that the blade angle of the downstream centrifugal impeller 100B is smaller than that of the upstream stage centrifugal impeller 100A. At least in a part of the shroud-side blade angle distribution curve which is convex in the small blade angle direction, the blade angle of the downstream centrifugal impeller 100B is smaller than that of the upstream stage centrifugal impeller 100A.

That is, the blade angle distribution in the vicinity of the blade leading edge (inlet) of the subsequent stage centrifugal impeller 100B is smaller than that of the initial stage centrifugal impeller 100A. With this arrangement, the blade load in the vicinity of the inlet (in the vicinity of blade leading edge) of the subsequent stage centrifugal impeller 100B is relatively small, and the surge margin is wider in the subsequent stage impeller 100B.

Generally, the surge in the uniaxial multistage centrifugal compressor such as a two stage centrifugal compressor is determined based on downstream-stage surge margin rather than upstream-stage surge margin. Accordingly, it is possible to further expand the surge margin of the entire multistage centrifugal compressor by changing the blade angle distribution in correspondence with each stage of the multistage centrifugal impeller 100 as described in the present embodiment. Especially, in a pipeline centrifugal compressor requiring a wide operating range, it is possible to obtain a gas pipeline centrifugal compressor with high efficiency and wide operating range by changing the blade angle distribution from the upstream-stage side centrifugal impeller toward the downstream-stage side centrifugal impeller as described above.

As described above, as the gas pipeline centrifugal compressor according to the present embodiment has the blade angle distribution as described above, on the low flow rate side, the blade load is small on the shroud side in the vicinity of the impeller inlet. Thus it is possible to suppress occurrence of stall and to obtain wide surge margin. Further, as the blade angle is large immediately rear of the impeller inlet on the hub side, the throat area is large. Thus it is possible to ensure the throat area in the entire impeller. Accordingly, it is also possible to suppress the reduction of choke flow rate. Further, on the blade trailing edge side of the shroud side, as the blade angle distribution curve is upwardly convex, the relative flow velocity is decelerated, and the increase of the wall friction loss is suppressed. With this arrangement, it is possible to design an impeller with high efficiency and wide operating range, and it is possible to obtain a gas pipeline centrifugal compressor with high efficiency and wide operating range.

Further, it is possible to obtain a gas pipeline to realize a compressor station having a low-price centrifugal compressor with wide operating range and high efficiency by adopting the above-described gas pipeline centrifugal compressor of the present embodiment as a centrifugal compressor for gas pressurization in a gas pipeline compressor station of a gas pipeline. That is, even when the flow rate in the gas pipeline is changed little by little, as it is possible to expand the operating range of the centrifugal compressor, it is not necessary to perform rotation velocity control, inlet guide vane control or the like, and it is possible to realize a low price compressor station.

1. A gas pipeline centrifugal compressor used in a gas pipeline having gas piping to transfer gas and a plurality of compressors for gas pressurization provided on a route of the gas piping,
wherein the centrifugal compressor has a centrifugal impeller fastened to a shaft, and the centrifugal impeller has a hub and a plurality of blades provided at intervals in a circumferential direction of the hub,
and wherein blade angle distribution of the blade is configured such that, when a hub side camber line connecting a hub side leading edge as a suction side end and a hub side trailing edge as a discharge side end of the blade is indicated with a lateral axis, and a hub side blade angle of the blade is indicated with a vertical axis, a hub side blade angle is maximum on a side closer to the hub side leading edge than a central point of the hub side camber line, and from a part where the blade angle is maximum to the hub side leading edge, a hub side blade angle distribution curve indicating the hub side blade angle distribution is convex in a blade angle increasing direction,
and configured such that, when a counter-hub side camber line connecting a counter-hub side leading edge as a suction side end on a counter-hub side and a counter-hub side trailing edge as a discharge side end of the blade is indicated with the lateral axis and a counter-hub side blade angle of the blade is indicated with the vertical axis, the counter-hub side blade angle is minimum at the counter-hub side leading edge of the counter-hub side camber line, or on a side closer to the counter-hub side leading edge than a central point of the counter-hub side camber line,
further configured such that, in an arbitrary section including a part where the blade angle is minimum in a counter-hub side blade angle distribution curve indicating the counter-hub side blade angle distribution, the counter-hub side blade angle distribution curve is convex in a small blade angle direction, and from a downstream side of the section where the counter-hub side blade angle distribution curve is convex to the counter-hub side trailing edge, the counter-hub side blade angle distribution curve is convex in a large blade angle direction.

2. The gas pipeline centrifugal compressor according to claim 1, wherein the centrifugal impeller has a hub fastened to the shaft, a shroud provided oppositely to the hub, and a plurality of blades positioned between the hub and the shroud and provided at intervals in the circumferential direction,
wherein when a shroud side camber line connecting a shroud side leading edge as a suction side end of the shroud side and a shroud side trailing edge as a discharge side end of the blade is indicated with the lateral axis, and the shroud side blade angle of the blade is indicated with the vertical axis, a shroud side blade angle is minimum at the shroud side leading edge of the shroud side camber line, or on a side closer to the shroud side leading edge than a central point of the shroud side camber line, in an arbitrary section including a part where the blade angle is minimum in the shroud-side blade angle distribution curve indicating a shroud-side blade angle distribution, the shroud-side blade angle distribution curve is convex in the small blade angle direction, and from the downstream side of the section where the shroud-side blade angle distribution curve is convex to the shroud side trailing edge, a curve indicating the shroud-side blade angle distribution curve is convex in the large blade angle direction.

3. The gas pipeline centrifugal compressor according to claim 2, wherein in the section where the hub side blade angle distribution curve is convex in the blade angle increasing direction, the hub side blade angle distribution curve has no inflection point.

4. The gas pipeline centrifugal compressor according to claim 2, wherein the position where the counter-hub side blade angle is minimum is the counter-hub side leading edge.

5. The gas pipeline centrifugal compressor according to claim 2, wherein the counter-hub side of the blade on the trailing edge side as the discharge end of the blade is tilted backward than the hub side in the rotational direction.

6. The gas pipeline centrifugal compressor according to claim 2, wherein the centrifugal impeller is provided in multiple stages,
and wherein the counter-hub side blade angle distribution curve is configured such that the blade angle in a downstream stage centrifugal impeller is smaller than that in an upstream stage centrifugal impeller.

7. The gas pipeline centrifugal compressor according to claim 6, wherein at least in a part where the counter-hub side blade angle distribution curve is convex in the small blade angle direction, the blade angle in the downstream stage centrifugal impeller is smaller than that of the upstream stage centrifugal impeller.

8. A gas pipeline comprising: a gas piping to transfer gas from a gas source to a gas supply destination; a compressor station having a centrifugal compressor for gas pressurization set in a plurality of positions on a route of the gas piping; a pressure regulator and a flow rate measurement unit provided between the compressor stations provided in the plurality of positions; a valve system provided in the gas piping between a most upstream compressor station in the plurality of compressor stations and the gas source; and a controller that controls the valve system, the compressor stations, the pressure regulator and the flow rate measurement unit, wherein the centrifugal compressor for gas pressurization is the gas pipeline centrifugal compressor in claim 2.
